(19) United States
(12) Patent Application Publication
(10) Pub. No.: US 2012/0019702 A1
(43) Pub. Date: Jan. 26, 2012

(54) METHOD FOR ADJUSTING AND FOR DISPLAYING THE ADJUSTMENT OF A CAMERA LENS

(76) Inventor: Claus Richter, Haltern am See (DE)

(21) Appl. No.: 13/125,034

(22) PCT Filed: Oct. 8, 2009
(86) PCT No.: PCT/EP2009/063074

§ 371 Date: Oct. 12, 2011

(51) Int. Cl. H04N 5/225

(52) U.S. Cl. 348/333.02; 348/E05.024

(57) ABSTRACT

A method for adjusting and for displaying the adjustment of a camera lens, in particular for adjusting the image sharpness (focus) of a camera lens for analog or digital motion picture cameras, comprising a scale shiftable relative to the display of a current adjustment value and coupled with an adjusting device. On the scale the adjustment values are represented numerically and/or as graphical symbols. A scale range bordering on the current adjustment value is located in a display window. At least one adjustment value is highlighted by a marking and a marking located outside the display window is displayed at the edge of the scale.

### CROSS-REFERENCE TO A RELATED APPLICATION

This application is a National Phase Patent Application of International Patent Application Number PCT/EP2009/063074, filed on Oct. 8, 2009, which claims priority of German Patent Application Number 10 2008 052 472.7, filed on Oct. 20, 2008.

### BACKGROUND

This invention relates to a method for adjusting and for displaying the adjustment of a camera lens, in particular for adjusting the image sharpness (focus) of a camera lens for analog and digital motion picture cameras and to an apparatus for carrying out the method.

An adjustment of the iris opening, the image sharpness (focus) and the focal length (zoom) can be performed at the lens rings of a camera lens. For an easier and more reliable adjustment of camera lenses, however, operating elements preferably are used which either are mounted at the motion picture camera itself or are formed as remote controls. For this purpose, a plurality of motor units are arranged at a camera lens, which each transmit a torque to the gear rim of a lens ring via a pinion and in this way effect an adjustment of the lens ring. The individual motor units are connected with a control unit which in turn is controlled via an operating unit.

In particular the image sharpness adjustment (focus) of a motion picture camera usually is not made directly at the lens ring of the camera lens, but at a so-called follow focus means, which offers a more expedient user interface for a camera assistant and as compared to an adjustment at the lens ring the advantages of a more comfortable operating position, a finer translation of the operating movement during the image sharpness adjustment, an optional remote controllability, the display of additional information such as the respective depth of field, and the possibility of marking certain distance settings which correspond for example with measured positions in the motif.

From DE 42 19 331 A1 a control system for camera lenses is known, which consists of a hand-held operating unit for adjusting the focal length, the image sharpness and the iris opening of a camera lens, motor units for the image sharpness adjustment, focal length adjustment and iris adjustment as well as a camera accumulator. For adjusting focal length, image sharpness and iris, the motor units each transmit a torque via pinions to the corresponding lens rings of the camera lens. The hand-held operating units each include a handwheel which similar to a mechanical follow focus means is formed with removable scale disks and shiftable, mechanically adjustable limit stops. By means of the shiftable limit stops the user can adjust certain key values of his adjustment, for which purpose separate marks can be provided on the scale disks alternatively or in addition.

For a precise adjustment of the sharpness and aperture ring, operating elements are provided for the electronic adjustment and limitation of the range in which the image sharpness and image aperture can be varied. In this way the adjustment range can be limited as desired. For the limited range, however, the full range of rotation of the handwheel of the operating units is available within the adjusted handwheel limit stops, so that the adjustment of the sharpness and aperture ring can be effected with extreme precision. This corresponds to the reduction provided in mechanical follow focus means for a particularly sensitive control.

Furthermore, the range limitation of the sharpness and aperture adjustment provides for exactly and repeatably positioning the sharpness and aperture ring corresponding to the adjustment values defined by the range boundaries, so that in the case of a repetition of shooting scenes defined start and end conditions can be employed.

Beside a numerical representation of the respectively adjusted image sharpness, focal length or iris adjustment, an adjustable, analog scale representation on the operating unit can also be provided in conjunction with the marking of certain adjustment values which are represented as graphical elements.

However, these known adjustment possibilities and indications of values of the image sharpness, focal length or iris adjustment set on a camera lens have some disadvantages in particular with respect to the image sharpness or focus adjustment.

On the one hand, when using a marking disk there is often not enough space on the circumference of the marking disk, in order to precisely mark adjustment values located close to each other. On the other hand, in the case of a remote control with graphically indicated scale the adjustment values to be marked can be entered precisely, but to be able to indicate the same clearly and distinctly, the scale must be spread correspondingly. Since the size of the displays of the operating units is limited, however, because of the limited size of the operating units for a manual operation, only a small segment of the entire adjustment range of the camera lens can each be represented on the display or display window of the operating units. This can result in the fact that adjustment values provided with markings disappear from the display window of the adjustable scale, for example when another sharpness range of the scale indicating the image sharpness is set. If a user now wants to shift the sharpness adjustment back to a marked adjustment value, it is very difficult for the user to estimate how far it each is to the desired marking, as the same will only appear shortly before reaching the adjustment value in the adjustment range of the scale set in the display window.

In the case of several markings, finding desired markings is even more complicated for the operator, since upon appearance of the respective markings the operator must also recognize whether this is the desired, correct marking.

### SUMMARY

Therefore, it is the object of the present invention to provide a method for adjusting and for displaying the adjustment of a camera lens as mentioned above, which ensures an optimum recognizability of adjustment values on an analog, adjustable scale with markings for adjustment values at any position.

By varying the scale of an analog, adjustable scale for displaying adjustment values of a camera lens, the solution in accordance with the invention provides for an optimum readability and recognizability of the adjustment values and for easily setting and retrieving in particular a plurality of markings at arbitrary positions of the adjustable, analog scale.

The method of the invention thus ensures an optimum readability for a given camera lens by choosing the optimum scale for the respective camera lens when representing the adjustment values in the display window of the adjustable, analog scale. When shifting the scale, the adjustment values marked by a corresponding input at the operating unit do not disappear from the display window of the operating unit, but are displayed at the edge of the scale, so that they are always in the field of view of the user and change into the analog display region of the scale, when they move into the display window upon shifting the analog scale.

For a further optimization of the readability of the display, a marking located outside the display window is displayed at the end of the scale, at which it would be located on a virtually expanded scale, so that on shifting the analog scale the user can recognize in a clear and easy manner at which end of the scale range displayed in the display window the marking will change into the display window and whether the marking designates an increasing or decreasing adjustment value.

A further improvement of the recognizability of markings is achieved in that the marking located outside the display window is represented vertical to the orientation of the scale and its distance to the scale is indicated in dependence on how far outside the virtually expanded scale the respective marking is located.

By this method step not only the marking located outside the display region is displayed to the user, but also its distance from the scale range displayed in the display window, so that the user is not surprised by a change of the marking into the range of the analog scale displayed in the display window, but can recognize how far outside the range of the analog scale displayed in the display window the marking is located.

This variant of the method of the invention is particularly important in the case of a plurality of markings which are arranged one beside the other at the edge of the analog scale such that the marking which is located farthest away from the range displayed in the display window has the greatest distance from the scale, whereas the marking located closest to the display region will correspondingly be represented closer to the scale.

A further improvement of the recognizability of markings is achieved in that a plurality of adjustment values are represented by markings with different symbols and/or colors and/or alphanumeric characters.

With this type of representation it is achieved that with one look at the display window the user has a complete overview of the markings set and their distance from the scale range represented in the display window, wherein by an individual allocation of colors, symbols or alphanumeric characters the user can determine a sort order which facilitates the retrieval and selection of certain adjustment values identified by markings.

A further improvement of the recognizability of markings and the interpretation of the analog scale settings or graphical, alphanumeric or colored symbols displayed in the display window is achieved in that the markings located inside the display window are represented with larger symbols and/or alphanumeric characters beside their associated adjustment value than the markings located outside the range displayed in the display window.

To facilitate the tracking of markings by the user when shifting the analog scale, the markings located inside the display window move along with the shifting of the analog scale and at the respective end of the scale the markings leaving the range displayed in the display window are shifted into the marking regions oriented vertical to the longitudinal orientation of the scale, wherein the distance of the respective marking in this marking region of the scale depends on how far outside the range represented in the display window the respective marking is located with respect to the current adjustment value.

Exemplary, the markings are set by entering the adjustment values associated to the markings into an operating unit of the camera lens.

Beside the arrangement of markings at their associated adjustment values of the adjustable, analog scale and in the marking regions oriented vertical to the analog scale at the respective ends of the scale, the markings with their different symbols and/or colors and/or alphanumeric characters in conjunction with their associated adjustment values can additionally be represented in a table beside the analog scale, wherein the order of the markings and associated adjustment values represented in the table corresponds to the order on the scale.

Exemplary, the current adjustment value is indicated in the middle of the display window by a graphical symbol, in particular by a line covering the adjustable, analog scale. For example, the scale can be represented extending vertically in the display window, whereas the marking of the current adjustment value is highlighted by a horizontal line which for example is arranged in the middle of the range displayed in the display window.

In a further exemplary aspect of the solution of the invention, the current adjustment value can be shown enlarged as an alphanumeric character in a window faded in, i.e. the respectively current adjustment value is shown enlarged for example in a window designed in the manner of a speech bubble, in which an arrow points to the analog adjustment value of the adjustable scale.

Because of the multitude of possible adjustment values the method of the invention is suitable in particular for the representation of focus or image sharpness settings. It is found to be advantageous that adjustment values for the image sharpness (focus) are represented on the scale and parallel to the orientation of the scale adjustment values for the iris opening of the camera lens and the current adjustment values such as image sharpness and iris opening are shown enlarged as alphanumeric characters in windows faded in, which alphanumeric characters are aligned with the graphical symbol indicating the current adjustment value.

An apparatus for carrying out the method includes at least one focus drive unit, zoom drive unit and iris drive unit, an operating unit connected with the focus drive unit, zoom drive unit and iris drive unit via an electric line or via a radio link, which contains a display window with adjustment values represented as numerical and/or graphic symbols in a scale range, a means for entering markings for selected adjustment values, a means for selecting entered markings and a control means actuating the display window and outputting control signals for selecting the markings to the focus drive unit, zoom drive unit and iris drive unit.

### BRIEF DESCRIPTION OF THE DRAWINGS

With reference to embodiments illustrated in the drawing the idea underlying the invention will be explained in detail and further variants of the solution in accordance with the invention will be represented.

FIG. 1—shows a schematic representation of a control, regulating and monitoring system for a motion picture camera and a camera lens with a plurality of operating units.

FIG. 2—shows a schematic representation of the composition of a display window with an analog image sharpness scale.

### DETAILED DESCRIPTION

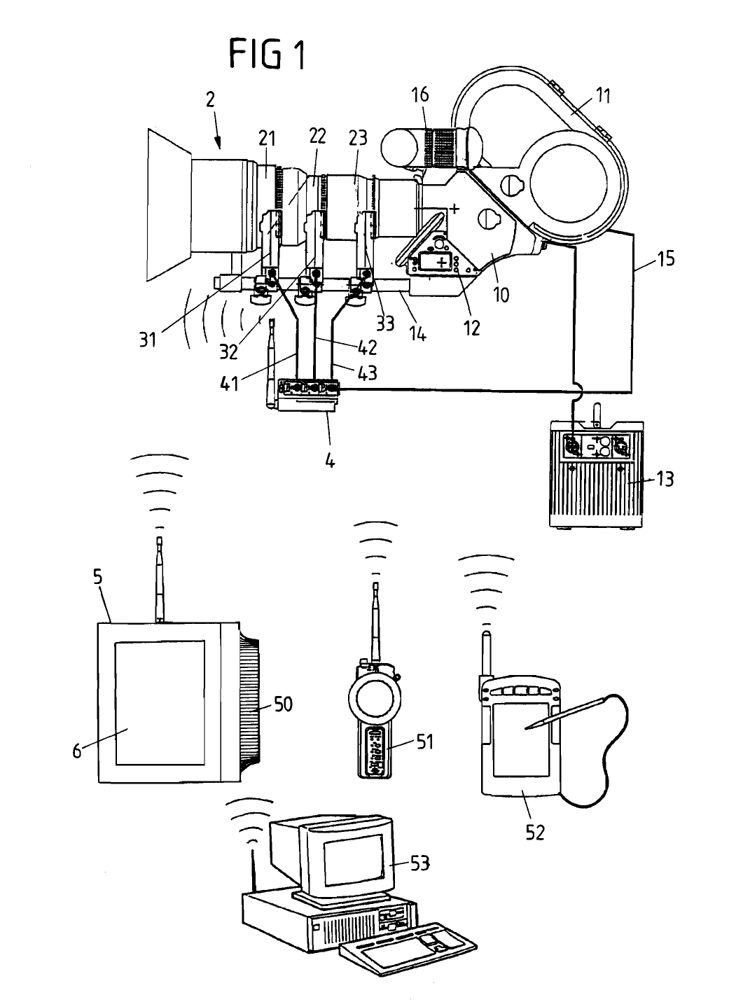

FIG. 1 schematically shows a control, regulating and monitoring system for an analog or digital motion picture camera 1, which provides for a wireless (radio) or alternatively cable-bound control and monitoring of camera functions as well as adjustment and display functions for a camera lens 2.

The motion picture camera 1 consists of a camera housing 10 with a camera mechanism for transporting a motion picture film, a rotating aperture disk and housing connections for a camera cassette 11, the camera lens 2 and a camera viewfinder 16 as well as a control panel 12 for adjusting, storing and retrieving various camera functions. On two iris rods 14 connected with the camera housing 10 a focus drive unit 31, a zoom drive unit 32 and an iris drive unit 33 are arranged, which are formed for example corresponding to the drive units as disclosed in DE 42 20 129 A1. The power supply of the motion picture camera 1 is effected from an accumulator 13, which is arranged separate from the camera housing 10 or integrated in the camera housing 10.

The camera lens 2 connected with the lens mount of the motion picture camera 1 includes lens rings 21, 22, 23 which are coupled with the drive units 31, 32, 33. From the camera lens 2, i.e. via the lens rings 21, 22, 23, the drive units 31, 32, 33 receive data on the image sharpness, zoom and iris adjustment of the camera lens 2 and for their part drive the lens rings 21, 22, 23 of the camera lens 2. Furthermore, the drive units 31, 32, 33 output detection signals on the actual values of the image sharpness, the zoom adjustment and the iris adjustment to the motion picture camera 1 or a camera-side control and detection unit 4 and receive signals for the desired image sharpness, desired zoom adjustment and desired iris adjustment from the motion picture camera 1 or the control and detection unit 4.

Via a connection line 15, the control, regulating and monitoring unit of the motion picture camera 1 is connected with the camera-side control and detection unit 4 to which the focus drive unit 31, the zoom drive unit 32 and the iris drive unit 33 also are connected via lines 41, 42, 43. The control, regulating and monitoring unit of the motion picture camera 1 controls and monitors the various camera functions such as transport velocity of the motion picture film, adjustment of the aperture mirror, actuation of a video presentation, cassette-side data such as type of cassette, length of the exposed and unexposed film, the focus, zoom and iris adjustment of the camera lens 2, etc.

The camera-side control and detection unit 4 is designed for radio and/or cable operation and correspondingly connected with operating units 5, 51, 52, 53 via a radio and/or cable connection. From the motion picture camera 1 or the control and detection unit 4 signals on the current adjustment values of the camera lens 2 and the motion picture camera 1 are output to the operating units 5, 51, 52, 53 and signals on the selected lens values, the selected camera values and calculated combination values, such as the iris image frequency, are received.

On the operating side a first operating unit 5 is provided, which serves the adjustment and indication of the image sharpness or the focus of the camera lens 2 and also is referred to as “follow focus means”. In addition, the operating unit 5 can, however, also be used for zoom and iris adjustment of the camera lens 2. A second operating unit 51 for example serves for the adjustment of camera functions, but alternatively or in addition also for the zoom and iris adjustment of the camera lens 2. A third operating unit 52 is designed as “pen-based computer” which as a hand-held terminal for data transmission not only serves for entering control commands, but also for performing monitoring functions, i.e. for the display and storage of camera- and shot-specific data. A third operating unit 53 is formed as workstation which performs the display, monitoring and logging of all camera- and shot-specific data and provides for entering control commands, specifies priorities of the operating units 5, 51 and 52, etc.

In the following, reference is made to the operating unit 5, which serves the adjustment and display of the image sharpness or focus and the display of the iris adjustment of the camera lens 2. This exemplary reference to the image sharpness and iris adjustment of the camera lens 2 can of course also be applied or expanded to other adjustments of the camera lens 2.

The operating unit or follow focus means 5 is designed as hand-held operating unit and includes an adjustment wheel 50 for focus adjustment and a display window 6 in which the current adjustment value of the image sharpness or the focus of the camera lens 2 is displayed in analog and/or digital form. By rotating the adjustment wheel 50 in the one or other direction of rotation, for example desired values for the focus adjustment can be entered and markings can be set by pressing the adjustment wheel 50 in axial direction. Alternatively or in addition, the display window 6 can constitute a touch-sensitive screen, so that adjustments can be made in the display window 6 itself.

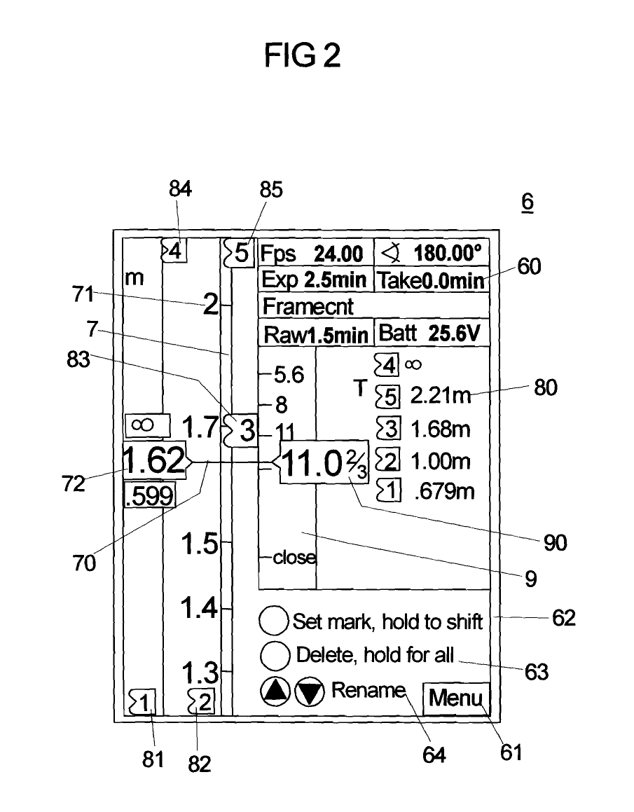

FIG. 2 shows a schematic representation of an example for the image composition and the data input in the case of a display window 6 formed as touch-sensitive screen as shown in FIG. 1.

The display window 6 of the operating unit 5 includes an analog image sharpness scale 7 formed as vertical bar with entered adjustment values 71 for the image sharpness or focus of the camera lens 2. The analog scale 7 can be shifted for example by means of the handwheel 5, so that in the top view of the display window 6 as shown in FIG. 2 the adjustment values 71 are shifted upwards or downwards in dependence on the direction of rotation of the handweel 5. The respective actual value of the image sharpness adjustment is marked by a horizontal line 70 for the analog display of the set image sharpness adjustment value or numerically indicated in an enlarged representation in a window 72 faded in, which is formed in the manner of a speech bubble.

In addition, a window 60 is faded in in the display window 6, in which data of the motion picture camera such as the image frequency, the angle of the rotating aperture mirror, the time period of a clock cycle, the battery voltage etc. are displayed. In a further scale 9 the adjustment values of the iris adjustment are represented, which are displayed with respect to the horizontal line 70 for indicating the actual value of the image sharpness setting in an enlarged numerical representation in a window 90 formed in the manner of a speech bubble.

In a further region 63 of the touch-sensitive display window 6 symbols for setting, cancelling and renaming adjustment values and markings are indicated.

For marking adjustment values 71 of the image sharpness marking symbols 81 to 85 are used, which are provided with different numerals and preferably also different colors for clear distinction. In FIG. 2 five markings 81 to 85 are depicted by way of example, in which the marking 81 is designated with “1” and marks an adjustment value of 0.679 m, the marking 82 is designated with “2” and marks a setting of 1.00 m, the marking 83 is designated with “3” and marks a setting of 1.68 m, the marking 84 is designated with “4” and marks the setting ∞, and the marking 85 is designated with “5” and indicates an adjustment value of 2.21 m for the image sharpness.

The markings 81, 82 located in the adjustment region of the display window 6 are represented with enlarged symbols for example in square fields with a notch beside the adjustment value 71 indicated on the analog scale 7 and moved along with the scale 7.

Since the scale range represented in the display window 6 extends from about 1.3 to 2.5 m, the markings 83 and 85 within the scale range are represented as enlarged markings, whereas the markings 81, 82 and 84 are located outside the scale range displayed and at one of the two ends of the analog scale 7 are represented in a marking region at the upper and lower edges of the display window 6 vertical to the orientation of the scale 7.

The markings 81, 82 and 84 located outside the marking region shown in the display window 6 are represented at the end of the analog scale 7, at which they would be located on a virtually expanded scale 7. The markings 81, 82 and 84 located outside the scale range are shifted horizontally relative to the scale 7, in order to show how far outside the scale range displayed in the display window 6 the respective markings 81, 82 and 84 currently are located, i.e. with respect to the respectively set actual value of the image sharpness adjustment. As shown in FIG. 2 at the lower edge of the display window 6, the two markings 81 and 82 for the focus settings 0.679 m and 1.00 m, which are located outside the scale range displayed in the display window 6, are represented in the correct order in the lower marking region at a distance from the analog scale 7 which would correspond to their order in a virtually expanded analog scale 7.

In addition, the markings 81 to 85 are displayed in the order of the adjustment values identified by them in a marking table 80 of adjustment values decreasing from top to bottom (or vice versa with increasing adjustment values).

The current actual value of the image sharpness adjustment of 1.62 m is numerically represented on an enlarged scale in the display window 72 formed in the manner of a speech bubble. Above and below the display window 72 represented in the manner of a speech bubble the range boundaries for the image sharpness adjustment of the camera lens 2 are indicated, for example the values 0.559 m for the minimum and ∞ for the maximum focus. The display window with the numerical display of the iris adjustment, which likewise is formed in the manner of a speech bubble, displays the current adjustment value of 11.0 ⅔ for the iris adjustment.

Thus, the scale range of the scale 7 can be varied as desired, in order to provide for an optimum readability of the adjustment values 71 and markings 81 to 85 for the respectively used camera lens 2. The current sharpness adjustment is represented on the analog scale 7 both as numerical value in a window 72 faded in and as an adjustment value 71, and certain adjustment values 71 can be marked by actuating the touch-sensitive symbol 62 in the touch-sensitive display window 6, be cancelled by actuating the touch-sensitive symbol 63 and be changed by actuating the touch-sensitive symbols 64. In addition, by tapping on the field 61 a change into a menu is possible, which specifies various applications, displays and adjustments.

Due to the inventive design of the display the user has a clear view of the marked adjustment values. When shifting the sharpness range, the user can see which markings are reached in which order, even if the same are not yet represented in the scale range displayed. Furthermore, the user gets a hint as to how far shifting yet is necessary, until the respective markings are reached.

1-18. (canceled)

19. A method for adjusting and for displaying the adjustment of a camera lens, in particular for adjusting the image sharpness (focus) of a camera lens for analog or digital motion picture cameras, comprising a scale shiftable relative to the display of a current adjustment value and coupled with an adjusting device, on which scale the adjustment values are represented numerically and/or as graphical symbols, and of which a scale range bordering on the current adjustment value is located in a display window, wherein at least one adjustment value is highlighted by a marking and a marking located outside the display window is displayed at the edge of the scale.

20. The method according to claim 19, wherein the marking located outside the display window is displayed at the end of the scale at which it would be located on a virtually expanded scale.

21. The method according to claim 19, wherein the marking located outside the display window is represented vertical to the orientation of the scale and its distance to the scale is indicated in dependence on how far outside the virtually expanded scale the respective marking is located.

22. The method according to claim 19, wherein a plurality of adjustment values are represented by markings with different symbols and/or colors and/or alphanumeric characters.

23. The method according to claims 21, wherein markings for adjustment values which are located outside the display window are represented vertical to the orientation of the scale, wherein the distance of the respective marking from the scale depends on how far outside the display window the respective marking is located in dependence on the current adjustment value.

24. The method according to claim 23, wherein proceeding from the scale the markings located outside the display window are represented vertical to the scale in the order of the increasing or decreasing adjustment values.

25. The method according to claim 19, the markings located inside the display window are represented with larger symbols and/or alphanumeric characters beside their associated adjustment value than the markings located outside the display window.

26. The method according to claim 19, wherein the markings located inside the display window move along with the shifting of the scale and the markings leaving the display window at the respective end of the scale are shifted into display regions extending vertical to the longitudinal orientation of the scale, wherein the distance of the respective marking from the scale depends on how far outside the display window the respective marking is located with respect to the current adjustment value.

27. The method according to claim 19, wherein the markings are set by entering the adjustment values associated to the markings into an operating unit.

28. The method according to claim 19, wherein the markings with their different symbols and/or colors and/or alphanumeric characters in conjunction with their associated adjustment values are additionally represented in a marking table beside the scale.

29. The method according to claim 28, wherein the order of the markings and associated adjustment values represented in the marking table corresponds to the order on the scale.

30. The method according to claim 19, wherein the current adjustment value is indicated by a graphical symbol which substantially is located in the middle of the display window.

31. The method according to claim 30, wherein the graphical symbol indicating the current adjustment value covers the scale.

32. The method according to claim 30, wherein the current adjustment value is shown enlarged as an alphanumeric character in a window faded in.

33. The method according to claim 19, wherein adjustment values for the image sharpness (focus) are represented on the scale and parallel to the orientation of the scale adjustment values for the iris opening of the camera lens are represented and that the current adjustment values such as image sharpness and iris opening are shown enlarged as alphanumeric characters in windows faded in, which alphanumeric characters are aligned with the graphical symbol indicating the current adjustment value.

34. An apparatus for carrying out the method according to claim 19, comprising at least one focus drive unit, zoom drive unit and iris drive unit, an operating unit connected with the focus drive unit, zoom drive unit and iris drive unit via an electric line or via a radio link, which contains a display window with adjustment values represented as numerical and/or graphical symbols in a scale range, a means for entering markings for selected adjustment values, a means for selecting entered markings and a control means actuating the display window and outputting control signals for selecting the markings to the focus drive unit, zoom drive unit and iris drive unit.

35. The apparatus according to claim 34, wherein the focus drive unit, zoom drive unit and iris drive unit are coupled with an associated lens ring of the camera lens, receive data on the image sharpness, zoom and iris adjustment of the camera lens and drive the lens rings of the camera lens for adjusting desired values of the image sharpness, zoom and iris adjustment of the camera lens.

36. The apparatus according to claim 35, wherein the focus drive unit zoom drive unit and iris drive unit output detection signals of the actual values of the image sharpness, the zoom adjustment and the iris adjustment to the motion picture camera or a camera-side control and detection unit and receive desired values for the image sharpness, zoom adjustment and iris adjustment from the motion picture camera or the control and detection unit.
